(19) United States
(12) Patent Application Publication
(10) Pub. No.: US 2012/0251735 A1
(43) Pub. Date: Oct. 4, 2012

(54) PRINTING CONDUCTIVE LINES

(76) Inventor: Israel Schuster, Petech-Tikva (IL)

(21) Appl. No.: 13/079,177

(22) Filed: Apr. 4, 2011

(51) Int. Cl. B05D 3/06; B05D 5/12

(52) U.S. Cl. 427/555; 427/58

(57) ABSTRACT

A method for printing conductive lines on a substrate includes printing a pattern of conductive material (204) on the substrate to; and sintering a first part of the pattern of conductive material.

### CROSS REFERENCE TO RELATED APPLICATIONS

Reference is made to commonly-assigned copending U.S. patent application Ser. No. ______ (Attorney Docket No. K000148US01/NAB), filed herewith, entitled PRINTING CONDUCTIVE LINES, by Schuster; the disclosure of which is incorporated herein.

### FIELD OF THE INVENTION

The present invention relates to writing conductive lines and conductive grids on media, and in particular to writing with an inkjet and laser combination.

### BACKGROUND OF THE INVENTION

One of the ultimate goals in electronics is the ability to directly write electronic components and circuits on a variety of substrates. Advancing materials chemistry and developing printhead technology is bringing this goal closer to reality.

Drop on demand inkjet printing applied to industrial processes, utilizes the piezo electric effect to deliver precise and consistent quantities of fluids to media or substrate. Such inkjet printing has a relatively low resolution, which might not be enough to print the fine details in circuit boards 100 as shown in FIG. 1.

Current methods for printing electronics on suitable substrates, for example applying material deposition, results in relatively thick lines, i.e. greater than 30 micrometers. Other methods, such as subtractive methods, which may be based upon laser writing and etching, may consume large amounts of expensive conductive material. FIG. 2 shows conductive grid lines 204 deposited by known printing methods such as inkjet deposition of conductive material on substrate 208.

The deposition of the conductive grid lines may also be done by flexographical means. The width of the grid lines formed depends on the printing method, but in general are not narrow enough to be used for high density circuit boards.

### SUMMARY OF THE INVENTION

Briefly, according to one aspect of the present invention a method for printing conductive lines on a substrate includes printing a pattern of conductive material on the substrate to; and sintering a first part of the pattern of conductive material.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 shows a prior art diagrammatic form of a printed circuit board;

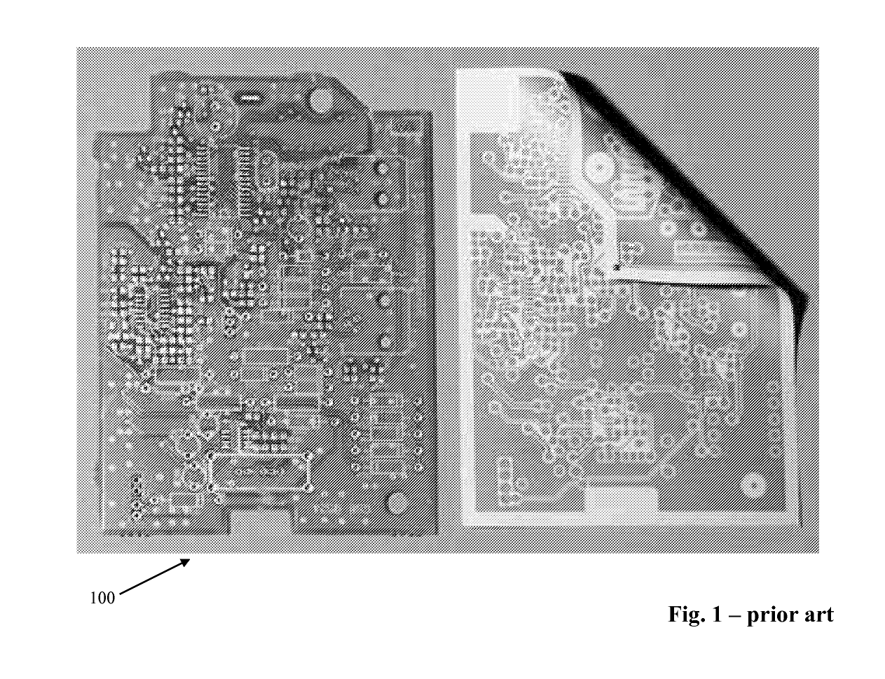

FIG. 2 represents in diagrammatic form a prior art imaging device adapted to form conductive lines using inkjet head and laser imaging head;

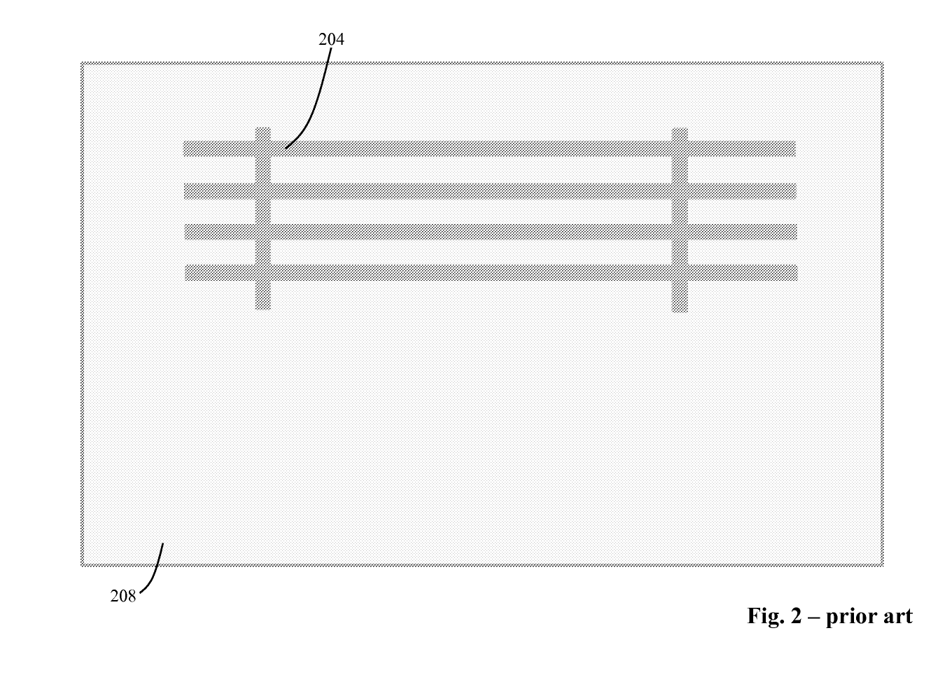

FIG. 3 represents in diagrammatic form an imaging head for forming conductive lines;

FIG. 4 represents in diagrammatic form conductive lines formed with inkjet means;

FIG. 5 represents in diagrammatic form sintered conductive lines previously imaged by inkjet means; and

FIG. 6 represents in diagrammatic form of sintered conductive lines after removing the non sintered inkjet material.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

While the present invention is described in connection with one of the embodiments, it will be understood that it is not intended to limit the invention to this embodiment. On the contrary, it is intended to cover all alternatives, modifications and equivalents as covered by the appended claims.

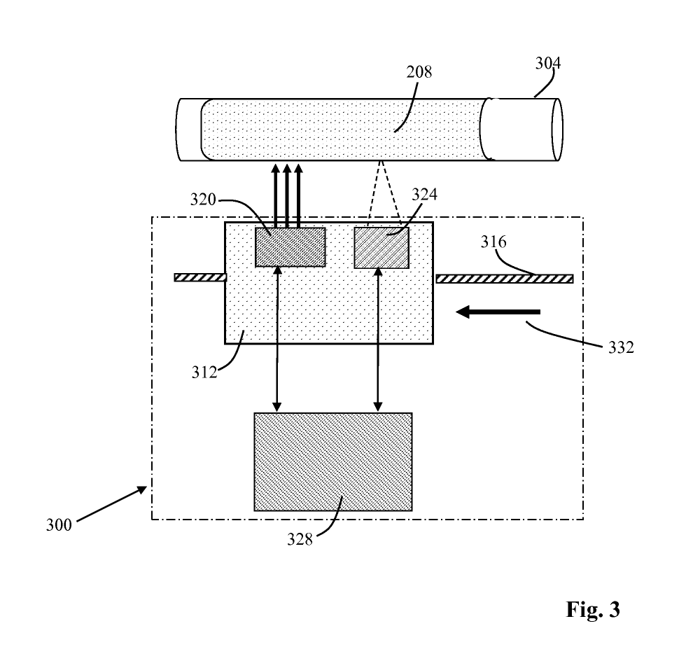

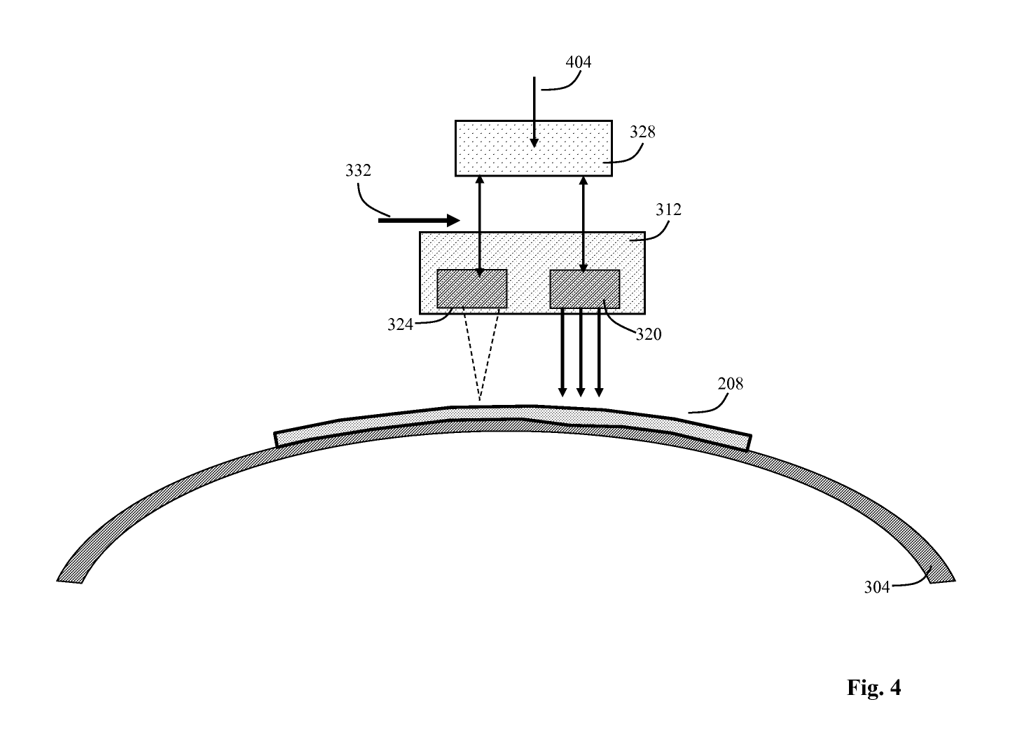

FIG. 3 shows an arrangement of an imaging device 300 configured to image conductive material on substrate 208. The substrate 208 in this arrangement is mounted on a rotating cylinder 304. The imaging device 300 contains a carriage 312. The carriage is adapted to move substantially in parallel to cylinder 304 guided by an advancement screw 316. An inkjet imaging head 320 is mounted on carriage 312, along with a laser source 324. The inkjet imaging head 320 is positioned on carriage 312 in such a manner that during scanning of carriage 312 (in direction 332), it precedes the laser source 324. Controller 328 coordinates and synchronizes the operation of inkjet head 320 and laser source 324. Controller 328 receives the data for imaging 404 (in FIG. 4) from a digital front end (not shown) and provides it to the inkjet head 320 and laser source 324. The inkjet head 320 deposits conductive lines 204 on substrate 208.

Following the deposition of the conductive lines 204 deposition, by inkjet head 320, a focused laser beam is applied by laser source 324. The thickness of sintering applied by the laser source 324 is variable and is adjusted by the spot size of the laser source 324. The laser source 324 scans lines 204 on the previously deposited lines 204.

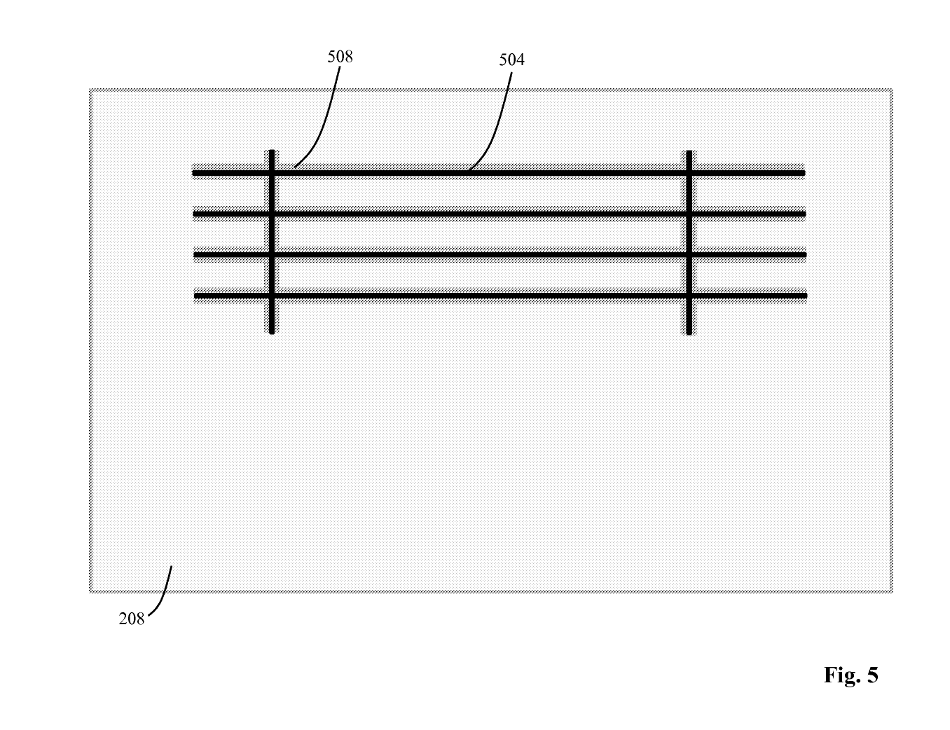

This process (the laser imaging on lines 204) sinters together the nano-particles of the ink deposited on lines 204. Since size of the laser spot can be made significantly smaller than the deposited line, the sintering process can form sintered grid lines 504 shown in FIG. 5, which are substantially narrower that lines 204. After the laser imaging a sintered metallic conductive line 504 is formed surrounded with un-sintered ink 508.

The un-sintered ink 508 is then removed with appropriate materials and complementary processes such as brushing with water (not shown). Alternatively an un-sintered removal element (not shown) can be added to imaging device 300 on carriage 312. The removal element will operate following to the laser source for sintering 324 on the un-sintered ink 508.

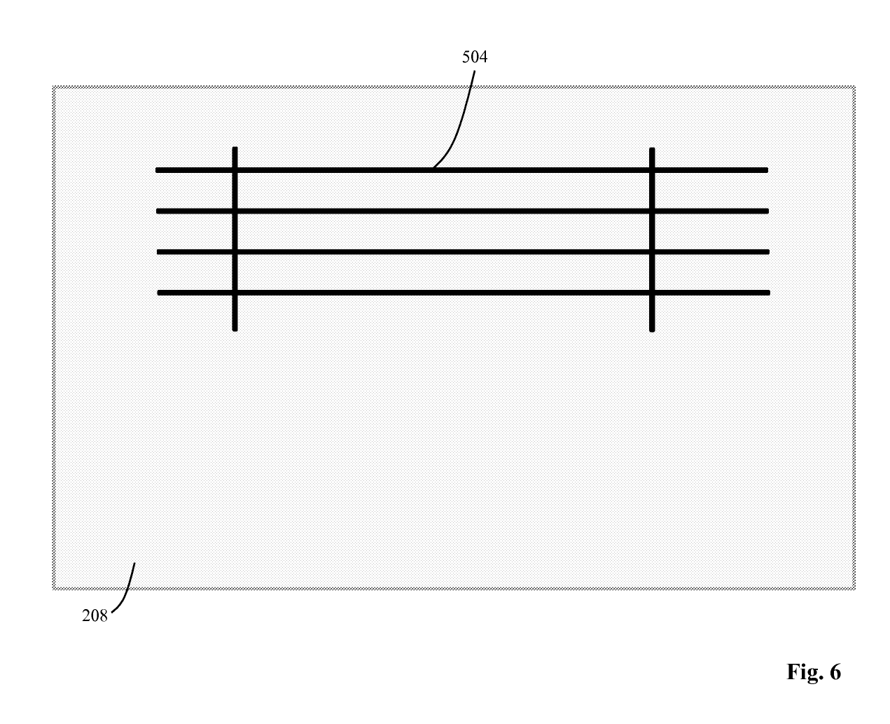

The result of the process using the device described above as is shown in FIG. 6, is a sintered metallic line 504 in the width of the focused laser beam and enhanced conductivity due to the nature of the sintering process.

The invention has been described in detail with particular reference to certain preferred embodiments thereof, but it will be understood that variations and modifications can be effected within the scope of the invention.

### PARTS LIST

100 printed circuit electronic board
204 inkjet formed conductive lines
208 substrate
300 imaging device
304 rotating cylinder
312 carriage
316 screw
320 inkjet imaging head
324 laser source for sintering
328 controller
332 carriage direction
404 imaging data
504 sintered conductive lines
508 conductive deposited material to be washed out

1. A method for printing conductive lines on a substrate comprising:
printing a pattern of conductive material on the substrate; and
sintering a first part of the pattern of conductive material.

2. The method of claim 1 further comprising:
removing a second part of the pattern of conductive material.

3. The method of claim 1 further comprising:
a third element for removing a second part of the pattern of conductive material.

4. The method of claim 3 wherein the third element removes the second part of the pattern of conductive material by washing.

5. The method of claim 1 wherein the imaging element is a laser.

6. The method of claim 1 wherein the printing element is an inkjet printhead.

7. The method according to claim 1 wherein the first part of the pattern is sintered in lines of various thickness.
